(19) United States
(12) Patent Application Publication
(10) Pub. No.: US 2023/0325729 A1
(43) Pub. Date: Oct. 12, 2023

(54) AIRCRAFT RESERVATION SYSTEM

(71) Applicant: HONDA MOTOR CO., LTD., Tokyo (JP)

(72) Inventor: Mitsutake Ando, Wako-shi (JP)

(21) Appl. No.: 18/176,524

(22) Filed: Mar. 1, 2023

(30) Foreign Application Priority Data
Mar. 30, 2022 (JP) 2022-057224

(51) Int. Cl. G06Q 10/02

(52) U.S. Cl. CPC G06Q 10/02

(57) ABSTRACT

An aircraft reservation system includes: a reservation acceptance unit; a recommended candidate flight extraction unit configured to extract a plurality of recommended candidate flights which satisfy a utilization spot condition and a utilization date and time condition and have a vacant seat; a reservation rate estimation unit configured to estimate a reservation rate at a time point a second predetermined time earlier than a desired departure date and time, for the plurality of recommended candidate flights; a recommended flight selection unit configured to select, as a recommended flight, the recommended candidate flight with the reservation rate at the time point when the reservation is accepted by the reservation acceptance unit being highest or the recommended candidate flight with the reservation rate estimated by the reservation rate estimation unit being highest among the plurality of recommended candidate flights; and a recommended flight proposal unit.

### INCORPORATION BY REFERENCE

The present application claims priority under 35 U.S.C.§119 to Japanese Patent Application No. 2022-057224 filed on Mar. 30, 2022. The content of the application is incorporated herein by reference in its entirety.

### BACKGROUND OF THE INVENTION

### Field of the Invention

The present invention relates to an aircraft reservation system.

### Description of the Related Art

Conventionally, there has been proposed a system of predicting and presenting a stock amount and stock-out time for vacant seats of an aircraft to a user of the aircraft at a time point of reservation inquiry so as to enable the user to reserve stock and specify a reservation condition (for example, see Japanese Patent Laid-Open No. 2003-256702).

In the conventional system described above, by providing a user with vacant seat stock information and allowing a reservation to be efficiently made, time and labor of a person who makes a reservation can be reduced. However, a passenger load factor of each aircraft is not taken into consideration. Therefore, there is room for improvement for increasing the passenger load factor and performing an efficient operation for an aircraft with a small seating capacity for passengers on such as a VTOL aircraft (Vertical Take-Off and Landing aircraft), in particular.

The present invention is implemented in consideration of such a background, and an object is to provide an aircraft reservation system which supports an efficient aircraft operation by increasing a passenger load factor.

### SUMMARY OF THE INVENTION

A first aspect for achieving the object described above is an aircraft reservation system including: a reservation acceptance unit configured to recognize a reservation condition including a desired departure place, a desired arrival place and a desired departure date and time or a desired arrival date and time by receiving flight reservation condition information transmitted from a user terminal used by a user of an aircraft, and accept a flight reservation; a recommended candidate flight extraction unit configured to refer to a flight database in which flight plans and reservation statuses of a plurality of flights are recorded, and extract a plurality of recommended candidate flights which satisfy both a utilization spot condition and a utilization date and time condition and have a vacant seat, the utilization spot condition indicating that a distance between a departure place and the desired departure place is a first predetermined distance or shorter and a distance between an arrival place and the desired arrival place is a second predetermined distance or shorter, the utilization date and time condition indicating that a time difference between a scheduled departure date and time and the desired departure date and time is a first predetermined time or shorter or a time difference between a scheduled arrival date and time and the desired arrival date and time is a second predetermined time or shorter; a recommended flight selection unit configured to select, as a recommended flight, the recommended candidate flight with a reservation rate at a time point when the reservation is accepted by the reservation acceptance unit being highest or the recommended candidate flight with an estimated reservation rate at the time point a third predetermined time earlier than the desired departure date and time, obtained by a reservation rate estimation unit, being highest among the plurality of recommended candidate flights; and a recommended flight proposal unit configured to transmit recommended flight proposal information which proposes a reservation of the recommended flight to the user terminal.

The aircraft reservation system described above may include a utilization charge reduction unit configured to set a utilization charge of the recommended flight to be lower than a utilization charge of the flight that conforms to the reservation condition, and the recommended flight proposal unit may transmit the recommended flight proposal information including the utilization charge of the recommended flight to the user terminal.

A second aspect for achieving the object described above is an aircraft reservation system including: an adjustment target flight extraction unit configured to refer to a flight database in which flight plans and reservation statuses of a plurality of flights are recorded, and extract an adjustment target flight a fourth predetermined time earlier than a scheduled departure date and time and with a reservation rate being a first determination value or lower; an alternative candidate flight extraction unit configured to refer to the flight database, and extract, among examination target flights which have a vacant seat and with the reservation rate being a second determination value higher than the first determination value or higher, a plurality of alternative candidate flights which are the examination target flights satisfying both a utilization spot condition and a utilization date and time condition, the utilization spot condition indicating that a distance between a departure place of the adjustment target flight and a departure place of the examination target flight is a third predetermined distance or shorter and a distance between an arrival place of the adjustment target flight and an arrival place of the examination target flight is a fourth predetermined distance or shorter, the utilization date and time condition indicating that a time difference between a scheduled departure date and time of the adjustment target flight and a scheduled departure date and time of the examination target flight is a fifth predetermined time or shorter or a time difference between a scheduled arrival date and time of the adjustment target flight and a scheduled arrival date and time of the examination target flight is a sixth predetermined time or shorter; a reservation rate estimation unit configured to obtain an estimated reservation rate at the time point the fifth predetermined time earlier than the scheduled departure date and time of the adjustment target flight, for the plurality of alternative candidate flights; an alternative flight selection unit configured to select, as an alternative flight, the alternative candidate flight with the reservation rate at the time point the fourth predetermined time earlier than the scheduled departure date and time of the adjustment target flight being highest or the alternative candidate flight with the estimated reservation rate at the time point a seventh predetermined time earlier than the scheduled departure date and time of the adjustment target flight, obtained by the reservation rate estimation unit, being highest among the plurality of alternative candidate flights; and a flight change proposal unit configured to transmit flight change proposal information which proposes a change of a reservation to the alternative flight to a user terminal used by a user who has a reservation of the adjustment target flight.

The aircraft reservation system described above may include a utilization charge reduction unit configured to set a utilization charge of the alternative candidate flight to be lower than a utilization charge of the adjustment target flight, and the flight change proposal unit may transmit the flight change proposal information including the utilization charge of the alternative candidate flight to the user terminal.

The aircraft reservation system described above may include a flight cancellation unit configured to cancel a low activity flight with the reservation rate at the time point when an eighth predetermined time earlier than the scheduled departure date and time is reached being a fourth determination value or lower or the estimated reservation rate at the time point a ninth predetermined time earlier than the scheduled departure date and time, obtained by the reservation rate estimation unit, is a fifth determination value or lower, among the flights recorded in the flight database.

In the aircraft reservation system described above, the flight cancellation unit may cancel the low activity flight on condition that the other flights are not affected.

According to the aircraft reservation system described above, it is possible to support an efficient aircraft operation by increasing a passenger load factor.

### BRIEF DESCRIPTION OF THE DRAWINGS

FIG. 1 is a block diagram of an aircraft reservation system;

FIG. 2 is a flowchart of recommended flight proposal processing;

FIG. 3 is an explanatory diagram of the recommended flight proposal processing;

FIG. 4 is a flowchart of flight change proposal processing;

FIG. 5 is an explanatory diagram of flight change processing;

FIG. 6 is a flowchart of flight cancellation processing; and

FIG. 7 is an explanatory diagram of the flight cancellation processing.

### DETAILED DESCRIPTION OF THE PREFERRED EMBODIMENTS

### 1. Configuration of Aircraft Reservation System

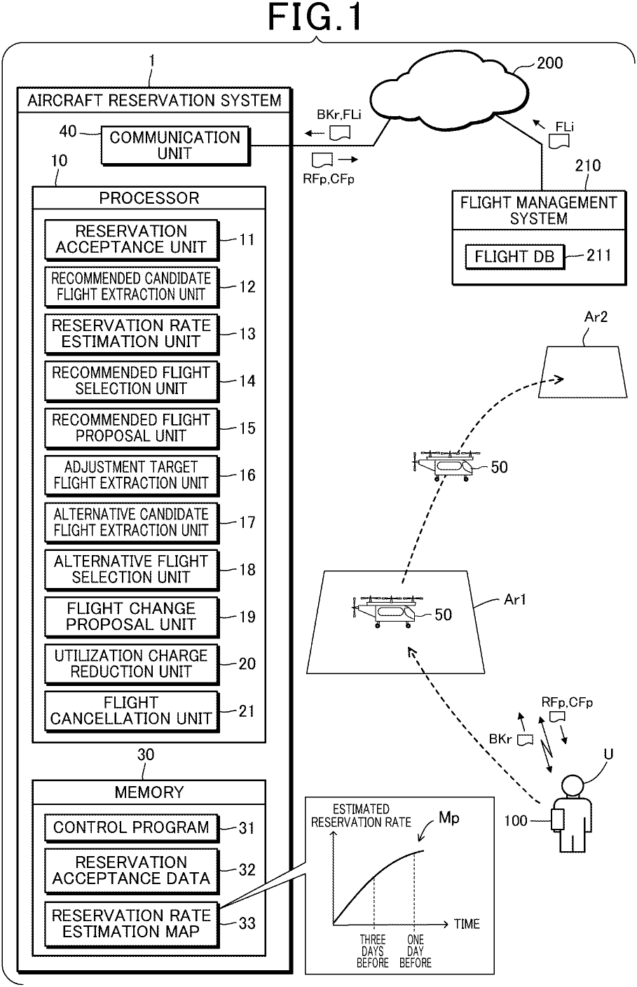

With reference to FIG. 1, the configuration of an aircraft reservation system 1 of the present embodiment will be explained. The aircraft reservation system 1 executes processing of supporting a reservation of a flight of an aircraft 50 by a user U. The aircraft 50 of the present embodiment is an aircraft of a vertical take-off and landing type such as a VTOL aircraft (Vertical Take-Off and Landing aircraft). The number of users who can board the aircraft 50 is four in the present embodiment but is not limited to four, and application of the aircraft reservation system of the present disclosure is especially effective when the number of users who can board a target aircraft is small.

The user U reserves a flight using an aircraft reservation application (application program) installed in a user terminal 100. The user U specifies a reservation condition of a flight that the user desires to utilize, and demands the reservation of the flight. The reservation condition includes a desired departure place, a desired arrival place, a desired departure date and time and a desired arrival date and time.

FIG. 1 illustrates a situation where the user U reserves and utilizes a flight by the aircraft 50 from a departure place Ar1 to an arrival place Ar2. The user terminal 100 is a communication terminal such as a smartphone, a cellular phone, a tablet terminal, a notebook computer and a desktop computer.

The aircraft reservation system 1 communicates with the user terminal 100 and a flight management system 210 or the like via a communication network 200. The flight management system 210 is a computer system including a processor, a memory and a communication unit or the like that are not shown in the figure. The flight management system 210 includes a flight DB (database) in which flight information FLi including flight plans and reservation statuses of a plurality of flights is recorded.

The aircraft reservation system 1 is a computer system including a processor 10, a memory 30 and a communication unit 40 or the like. The communication unit 40 communicates with the flight management system 210 and the user terminal 100 or the like via the communication network 200. In the memory 30, a control program 31 of the aircraft reservation system 1, reservation acceptance data 32 in which reservation information of the flight demanded by the user U or the like is recorded, and data 33 of a reservation rate estimation map Mp for estimating a future reservation rate of the flight recorded in the flight DB are preserved.

For the reservation rate estimation map Mp, estimated reservation rates at time points a predetermined time earlier than (one day before, two days before...) a scheduled departure date and time of the flight are mapped. The reservation rate estimation map is appropriately updated based on past reservation results of the individual flights or the like. In addition, a plurality of reservation rate estimation maps according to presence/absence of variable elements such as weather information and event holding information or the like near a departure place or an arrival place may be prepared and the reservation rate estimation map to be used may be switched according to the presence/absence of the variable elements.

The processor 10 functions as a reservation acceptance unit 11, a recommended candidate flight extraction unit 12, a reservation rate estimation unit 13, a recommended flight selection unit 14, a recommended flight proposal unit 15, an adjustment target flight extraction unit 16, an alternative candidate flight extraction unit 17, an alternative flight selection unit 18, a flight change proposal unit 19, a utilization charge reduction unit 20, and a flight cancellation unit 21 by reading and executing the control program 31.

The reservation acceptance unit 11 receives reservation condition information BKr transmitted from the user terminal 100, and records the reservation condition information BKr in the reservation acceptance data 32. The reservation acceptance unit 11 recognizes the reservation condition such as the desired departure place, the desired arrival place, the desired departure date and time and the desired arrival date and time indicated by the reservation condition information BKr, and accepts the reservation of the flight by the user U.

The recommended candidate flight extraction unit 12 extracts recommended candidate flights which satisfy a vacant seat condition, a utilization spot condition and a utilization time point condition below based on the reservation condition of the user U by recognizing the flight plans and the reservation statuses of the individual flights by accessing a flight DB 211 of the flight management system 210 and receiving the flight information FLi recorded in the flight DB 211.

The vacant seat condition...There is a vacant seat.

The utilization spot condition...The departure place and the desired departure place are the same, and the arrival place and the desired arrival place are the same. Note that the utilization spot condition may be that a distance between the departure place and the desired departure place is a first predetermined distance or shorter and a distance between the arrival place and the desired arrival place is a second predetermined distance or shorter.

The utilization date and time condition...A time difference between the scheduled departure date and time and the desired departure date and time is a first predetermined time or shorter.

The reservation rate estimation unit 13 obtains the estimated reservation rate at the time point a third predetermined time earlier than (for example, one day before) the scheduled departure date and time by the reservation rate estimation map Mp for the flights recorded in the flight DB. The recommended flight selection unit 14 selects, as a recommended flight, the recommended candidate flight with the estimated reservation rate obtained by the reservation rate estimation unit 13 being highest among the plurality of recommended candidate flights extracted by the recommended candidate flight extraction unit 12.

Note that, when there are the plurality of recommended candidate flights with the estimated reservation rate being the highest, the recommended flight selection unit 14 selects the one for which the time difference between the scheduled departure date and time and the desired departure date and time is shorter as the recommended flight, for example. In addition, the utilization charge reduction unit 20 sets the utilization charge of the recommended flight to be lower than a normal charge (a regular charge of the flight that conforms to a desired condition of the user U).

The recommended flight proposal unit 15 transmits recommended flight proposal information RFp which proposes the reservation of the recommended flight to the user terminal 100. The recommended flight proposal information RFp includes information of the departure place, the arrival place, the scheduled departure date and time, the scheduled arrival date and time and the utilization charge or the like of the recommended flight. In the user terminal 100, by the reservation application, an image which recommends utilization of the recommended flight by appealing the information of the recommended flight and the fact that the utilization charge of the recommended flight is lower than the regular charge is displayed. Thus, the user U is guided to the flight of the high reservation rate to be easily fully occupied, and efficient flight execution in a fully occupied state can be planned.

The adjustment target flight extraction unit 16 accesses the flight DB 211 of the flight management system 210 and extracts an adjustment target flight which satisfies a recent departure condition and a low reservation activity condition below from the flights recorded in the flight DB.

The recent departure condition...It has reached a fourth predetermined time earlier than (for example, one day before) the scheduled departure date and time.

The low reservation activity condition...The reservation rate at the present time point is a first determination value (for example, 25%) or lower.

The alternative candidate flight extraction unit 17 accesses the flight DB 211 of the flight management system 210, and extracts alternative candidate flights which are examination target flights satisfying an examination target condition below and which satisfy the utilization spot condition and the utilization date and time condition below, among the flights recorded in the flight DB.

The examination target condition...It is the examination target flight which has a vacant seat and with the reservation rate being a second determination value (for example, 50%) higher than the first determination value or higher.

The utilization spot condition...The departure places of the adjustment target flight and the examination target flight are the same and the arrival places of the adjustment target flight and the examination target flight are the same. Note that the utilization spot condition may be that a distance between the departure place of the adjustment target flight and the departure place of the examination target flight is a third predetermined distance or shorter and a distance between the arrival place of the adjustment target flight and the arrival place of the examination target flight is a fourth predetermined distance or shorter.

The utilization date and time condition...A time difference between the scheduled departure date and time of the adjustment target flight and the scheduled departure date and time of the examination target flight is a fifth predetermined time or shorter.

The alternative flight selection unit 18 selects, as an alternative flight, the alternative candidate flight with the estimated reservation rate at the time point a seventh predetermined time earlier than (for example, three days before) the scheduled departure date and time, obtained by the reservation rate estimation unit 13, being the highest among the plurality of alternative candidate flights extracted by the alternative candidate flight extraction unit 17. Note that, when there are the plurality of alternative candidate flights with the estimated reservation rate being the highest, the alternative flight selection unit 18 selects the one for which the time difference of the scheduled departure date and time from the adjustment target flight is shorter as the alternative flight, for example. In addition, the utilization charge reduction unit 20 sets the utilization charge of the alternative flight to be lower than the utilization charge of the adjustment target flight.

The flight change proposal unit 19 transmits flight change proposal information CFp which proposes a reservation change from the adjustment target flight to the alternative flight to the user terminal of the user who has a reservation of the adjustment target flight. FIG. 1 illustrates a case where the user U has a reservation of the adjustment target flight and the flight change proposal information CFp is transmitted to the user terminal 100.

The flight change proposal information CFp includes the information of the departure place, the arrival place, the scheduled departure date and time, the scheduled arrival date and time and the utilization charge or the like of the alternative flight. In the user terminal 100, by the reservation application, an image which recommends the reservation change from the adjustment target flight to the alternative flight by appealing the information of the alternative flight and the fact that the utilization charge of the alternative flight is lower than the adjustment target flight is displayed. Thus, the user U is guided to the flight of the high reservation rate to be easily fully occupied, and the efficient flight execution in the fully occupied state can be planned.

The flight cancellation unit 21 accesses the flight DB 211 of the flight management system 210, and extracts a low activity flight which satisfies a flight cancellation condition below.

The flight cancellation condition...The reservation rate is a fourth determination value (for example, 0%) or lower at the time point when an eighth predetermined time earlier than (for example, three days before) the scheduled departure date and time is reached, or the estimated reservation rate at the time point a ninth predetermined time earlier than (for example, one day before) the scheduled departure date and time, obtained by the reservation rate estimation unit 13, is a fifth determination value (for example, 25%) or lower.

The flight cancellation unit 21 cancels the execution of the extracted low activity flight. Thus, the execution of the flight of a low passenger load factor and low transportation efficiency can be avoided.

### 2. Recommended Flight Proposal Processing

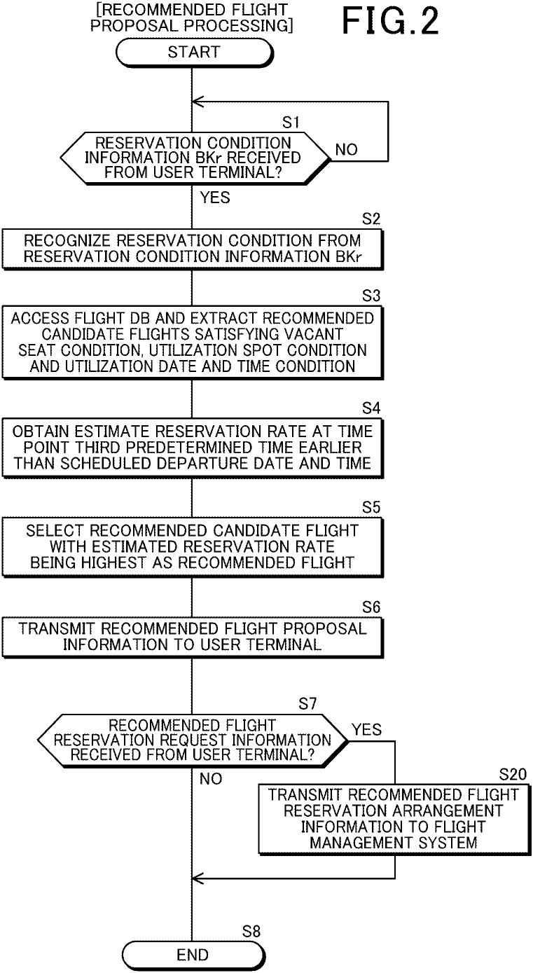

According to a flowchart illustrated in FIG. 2, a procedure of recommended flight proposal processing executed by the aircraft reservation system 1 in the situation illustrated in FIG. 1 will be explained.

In a step S1 in FIG. 2, when the reservation condition information BKr transmitted from the user terminal 100 is received, the reservation acceptance unit 11 advances the processing to a step S2. In the step S2, the reservation acceptance unit 11 records the reservation condition information BKr in the reservation acceptance data 32, recognizes the reservation condition desired by the user U from the reservation condition information BKr, and accepts the reservation of the flight.

In the following step S3, the recommended candidate flight extraction unit 12 accesses the flight DB 211 of the flight management system 210, and extracts the plurality of recommended candidate flights which satisfy the vacant seat condition, the utilization spot condition and the utilization date and time condition as described above. In the next step S4, the reservation rate estimation unit 13 obtains the estimated reservation rate at the time point the third predetermined time earlier than (for example, three days before) the desired departure date and time for the individual recommended candidate flight. In the following step S5, the recommended flight selection unit 14 selects, as the recommended flight, the recommended candidate flight with the estimated reservation rate obtained by the reservation rate estimation unit 13 being the highest among the plurality of recommended candidate flights extracted by the recommended candidate flight extraction unit 12.

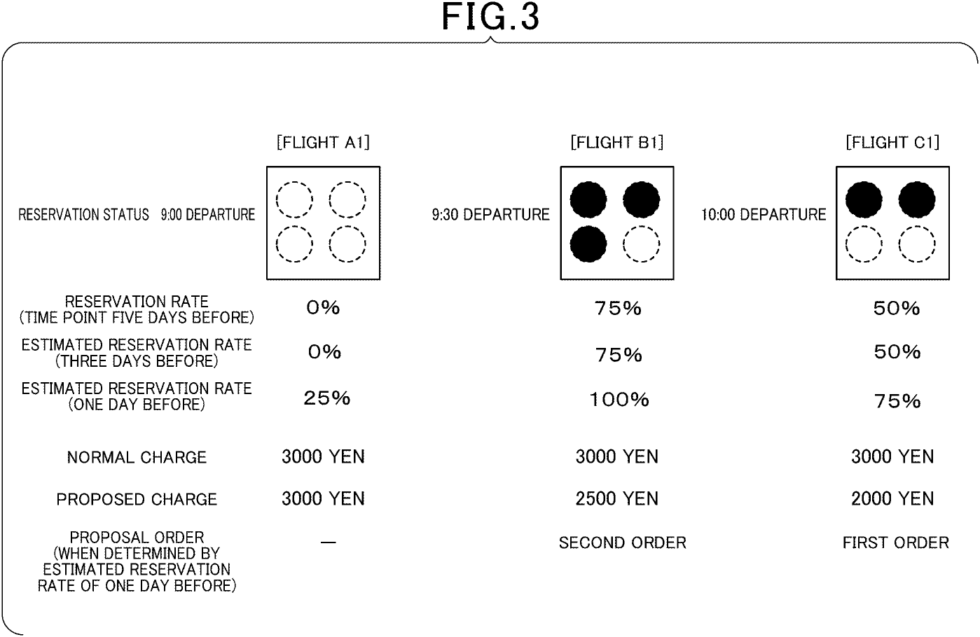

Here, with reference to FIG. 3, a recommended flight selection mode by the recommended flight selection unit 14 will be explained. FIG. 3 illustrates the case where a flight A1, a flight B1 and a flight C1 with the scheduled departure date and time of 9:00, 9:30 and 10:00 of the same date respectively are extracted by the recommended candidate flight extraction unit 12.

The reservation rate at the present time point (the time point of five days before the scheduled departure date, which is the time point of accepting the reservation), the estimated reservation rate of three days before, and the estimated reservation rate of one day before of the flight A1 are 0%→0%→25%. The reservation rate at the present time point, the estimated reservation rate of three days before, and the estimated reservation rate of one day before of the flight B1 are 75%→75%→100%. The reservation rate at the present time point, the estimated reservation rate of three days before, and the estimated reservation rate of one day before of the flight C1 are 50%→50%→75%.

In this case, the recommended flight selection unit 14 compares the estimated reservation rates of three days before, and selects the flight B1 with the estimated reservation rate of three days before being the highest as the recommended flight. Alternatively, the recommended flight selection unit 14 compares the estimated reservation rates of one day before, excludes the flight B1 with low necessity to be recommended since it is estimated that no vacant seat is to be available (reservation rate 100%), and selects the flight C1 of the higher estimated reservation rate between the flight A1 and the flight C1 as the recommended flight. Note that the reservation rates of the flights A1, B1 and C1 at the present time point may be compared and the flight B1 with the reservation rate being the highest may be selected as the recommended flight.

In the following step S6, the recommended flight proposal unit 15 transmits the recommended flight proposal information RFp to the user terminal 100. In the user terminal 100 which receives the recommended flight proposal information RFp, by the reservation application, an image which proposes the reservation of the recommended flight is displayed. In the following step S7, the reservation acceptance unit 11 advances the processing to a step S20 when reservation request information requesting the reservation of the recommended flight is received from the user terminal 100, and advances the processing to a step S8 when the reservation request information is not received.

In the step S20, the reservation acceptance unit 11 transmits reservation arrangement information which requests arrangements of the reservation of the recommended flight to the flight management system 210. Thus, the reservation of the user for the recommended flight is arranged.

### 3. Flight Change Processing

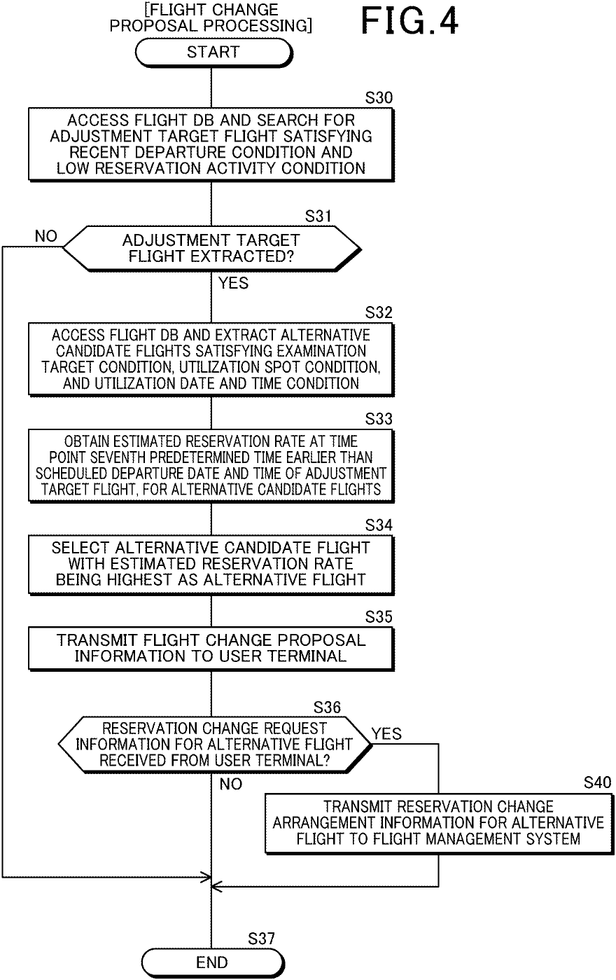

According to the flowchart illustrated in FIG. 4, a procedure of the flight change processing executed by the aircraft reservation system 1 will be explained. The aircraft reservation system 1 repeatedly executes the processing by the flowchart illustrated in FIG. 4 at predetermined confirmation timing.

In the step S30 in FIG. 4, the adjustment target flight extraction unit 16 accesses the flight DB 211 of the flight management system 210, and searches for the adjustment target flight which satisfies the recent departure condition and the low reservation activity condition described above. In the following step S31, the adjustment target flight extraction unit 16 advances the processing to a step S32 when the adjustment target flight is extracted, and advances the processing to a step S37 when the adjustment target flight is not extracted.

In the step S32, the alternative candidate flight extraction unit 17 accesses the flight DB 211 of the flight management system 210, and extracts the alternative candidate flights which satisfy the examination target condition, the utilization spot condition and the utilization date and time condition described above. In the following step S33, the reservation rate estimation unit 13 obtains the estimated reservation rate at the time point the seventh predetermined time earlier than (for example, three days before) the scheduled departure date and time of the adjustment target flight, for the plurality of alternative candidate flights extracted by the alternative candidate flight extraction unit 17.

In the next step S34, the alternative flight selection unit 18 selects, as the alternative flight, the alternative candidate flight with the estimated rate estimated by the reservation rate estimation unit 13 being the highest among the plurality of alternative candidate flights extracted by the alternative candidate flight extraction unit 17.

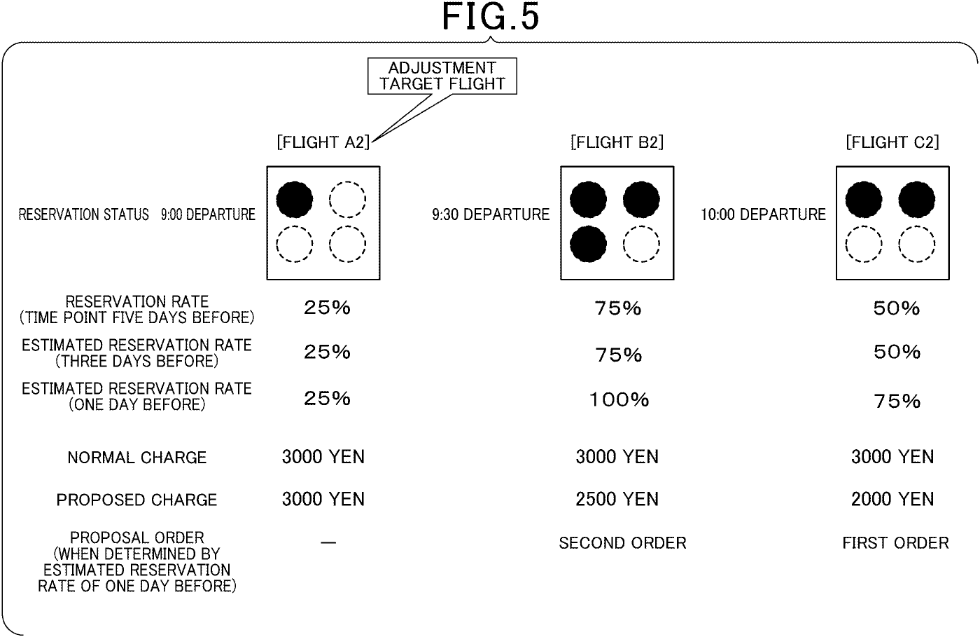

Here, with reference to FIG. 5, alternative flight selection processing by the alternative flight selection unit 18 will be explained. FIG. 5 illustrates the case where a flight B2 and a flight C2 are extracted as the alternative candidate flights for a flight A2 which is the adjustment target flight. The scheduled departure date and time of the flight A2, the flight B2 and the flight C2 is 9:00, 9:30 and 10:00 of the same date respectively.

The reservation rate at the present time point (the time point of five days before the scheduled departure date and time of the adjustment target flight, which is the time point of extracting the adjustment target flight), the estimated reservation rate of three days before, and the estimated reservation rate of one day before of the flight A2 are 25%→25%→25%. The reservation rate at the present time point, the estimated reservation rate of three days before, and the estimated reservation rate of one day before of the flight B2 are 75%→75%→100%. The reservation rate at the present time point, the estimated reservation rate of three days before, and the estimated reservation rate of one day before of the flight C2 are 50%→50%→75%.

In this case, the alternative flight selection unit 18 compares the estimated reservation rates of three days before between the flight B2 and the flight C2, and selects the flight B2 with the estimated reservation rate three days before being the highest as the alternative flight. Alternatively, the alternative flight selection unit 18 compares the estimated reservation rates of one day before between the flight B2 and the flight C2, excludes the flight B2 with low necessity to be an alternative since it is estimated that no vacant seat is to be available (reservation rate 100%), and selects the flight C2 as the alternative flight.

In the following step S35, the flight change proposal unit 19 transmits flight change proposal information CFp to the user terminal 100. In the user terminal 100 which receives the flight change proposal information CFp, by the reservation application, the image which proposes the reservation change from the adjustment target flight to the alternative flight is displayed. In the next step S36, the reservation acceptance unit 11 advances the processing to a step S40 when reservation change request information which requests the reservation change from the adjustment target flight to the alternative flight is received from the user terminal 100, and advances the processing to a step S37 when the reservation change request information is not received.

In the step S40, the reservation acceptance unit 11 transmits reservation change arrangement information which requests the arrangements of the reservation change from the adjustment target flight to the alternative flight to the flight management system 210. Thus, the reservation change from the adjustment target flight to the alternative flight is arranged.

### 4. Flight Cancellation Processing

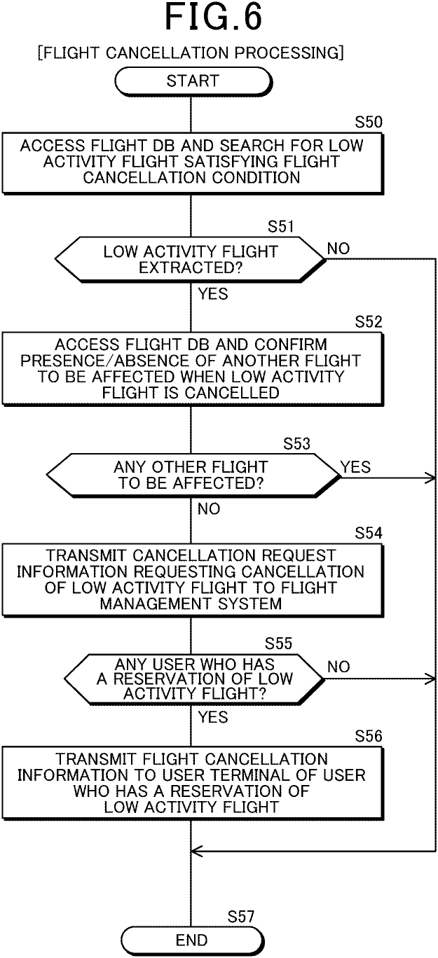

According to a flowchart illustrated in FIG. 6, the flight cancellation processing executed by the aircraft reservation system 1 will be explained. The aircraft reservation system 1 repeatedly executes the processing by the flowchart illustrated in FIG. 6 at the predetermined confirmation timing.

In the step S50 in FIG. 6, the flight cancellation unit 21 accesses the flight DB 211 of the flight management system 210, and searches for the low activity flight which satisfies the flight cancellation condition described above. In the following step S51, the flight cancellation unit 21 advances the processing to a step S52 when the low activity flight is extracted, and advances the processing to a step S57 when the low activity flight is not extracted.

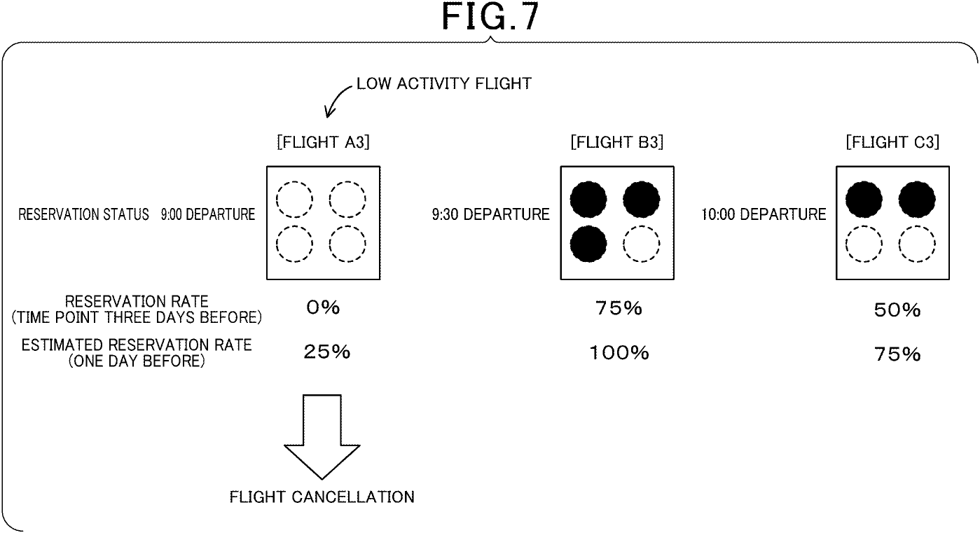

Here, with reference to FIG. 7, low activity flight extraction processing by the flight cancellation unit 21 will be explained. FIG. 7 illustrates an example that the flight cancellation unit 21 extracts the low activity flight from the flights A3, B3 and C3 for which the information is recorded in the flight DB 211. The flight cancellation unit 21 extracts the flight A3 with the reservation rate at the present time point (here, the time point of three days before the scheduled departure date and time) being 0% and the estimated reservation rate of one day before the scheduled departure date and time is 25% as the low activity flight.

In the step S52, the flight cancellation unit 21 accesses the flight DB 211 of the aircraft reservation system 1, and confirms presence/absence of another flight to be affected when the low activity flight is canceled. In the following step S53, the flight cancellation unit 21 advances the processing to a step S57 when there is another flight to be affected, and in this case, the low activity flight is not canceled.

On the other hand, when there is no other flight to be affected, the flight cancellation unit 21 advances the processing from a step S53 to a step S54, and transmits cancellation request information which requests cancellation of the low activity flight to the flight management system 210. Thus, low activity flight cancellation processing is executed in the flight management system 210, and the flight plan of the low activity flight is deleted from the flight DB 211.

In the following step S55, the flight cancellation unit 21 determines the presence/absence of the user U who has a reservation of the low activity flight, advances the processing to a step S56 when there is the user U who has a reservation of the low activity flight, and advances the processing to a step S57 when there is no user U who has a reservation of the low activity flight. In the step S56, the flight cancellation unit 21 transmits flight cancellation information which notifies that the reserved flight is cancelled to the user terminal 100 of the user U who has a reservation of the low activity flight.

### 5. Other Embodiments

While the flight cancellation unit 21 is provided and the processing of cancelling the flight of the low reservation rate is performed in the embodiment described above, the flight cancellation unit 21 may be omitted.

In the embodiment described above, the recommended flight proposal processing is executed by providing the recommended candidate flight extraction unit 12, the recommended flight selection unit 14 and the recommended flight proposal unit 15, and the flight change proposal processing is executed by providing the adjustment target flight extraction unit 16, the alternative candidate flight extraction unit 17, the alternative flight selection unit 18 and the flight change proposal unit 19. As another configuration, only either one of the recommended flight proposal processing and the flight change processing may be executed.

In the embodiment described above, the recommended candidate flight extraction unit 12 uses the fact that the time difference between the scheduled departure date and time and the desired departure date and time is the first predetermined time or shorter as the utilization date and time condition for extracting the recommended candidate flights. As another embodiment, the fact that the time difference between the scheduled arrival date and time and the desired arrival date and time is a second predetermined time or shorter may be the utilization date and time condition.

In the embodiment described above, the alternative candidate flight extraction unit 17 uses the fact that the time difference between the scheduled departure date and time of the adjustment target flight and the scheduled departure date and time of the examination target flight is the fifth predetermined time or shorter as the utilization date and time condition for extracting the alternative candidate flights. As another embodiment, the fact that the time difference between the scheduled arrival date and time of the adjustment target flight and the scheduled arrival date and time of the examination target flight is a sixth predetermined time or shorter may be the utilization date and time condition.

Note that FIG. 1 is a schematic diagram in which a functional configuration of the aircraft reservation system 1 is divided according to main processing contents and illustrated in order to facilitate understanding of the claimed invention, and the configuration of the aircraft reservation system 1 may be configured by other divisions. In addition, the processing of individual components may be executed by one hardware unit or may be executed by a plurality of hardware units. Further, the processing by the individual components illustrated in FIG. 2, FIG. 4 and FIG. 6 may be executed by one program or may be executed by a plurality of programs.

### 6. Configurations Supported by Embodiments Described Above

The embodiments described above are specific examples of the configurations below.

(Configuration 1) An aircraft reservation system including: a reservation acceptance unit configured to recognize a reservation condition including a desired departure place, a desired arrival place and a desired departure date and time or a desired arrival date and time by receiving flight reservation condition information transmitted from a user terminal used by a user of an aircraft, and accept a flight reservation; a recommended candidate flight extraction unit configured to refer to a flight database in which flight plans and reservation statuses of a plurality of flights are recorded, and extract a plurality of recommended candidate flights which satisfy both a utilization spot condition and a utilization date and time condition and have a vacant seat, the utilization spot condition indicating that a distance between a departure place and the desired departure place is a first predetermined distance or shorter and a distance between an arrival place and the desired arrival place is a second predetermined distance or shorter, the utilization date and time condition indicating that a time difference between a scheduled departure date and time and the desired departure date and time is a first predetermined time or shorter or a time difference between a scheduled arrival date and time and the desired arrival date and time is a second predetermined time or shorter; a recommended flight selection unit configured to select, as a recommended flight, the recommended candidate flight with a reservation rate at a time point when the reservation is accepted by the reservation acceptance unit being highest or the recommended candidate flight with an estimated reservation rate at the time point a third predetermined time earlier than the desired departure date and time, obtained by a reservation rate estimation unit, being highest among the plurality of recommended candidate flights; and a recommended flight proposal unit configured to transmit recommended flight proposal information which proposes a reservation of the recommended flight to the user terminal.

According to the aircraft reservation system of configuration 1, by proposing utilization of the flight of a high reservation rate to the user, it is possible to support an efficient aircraft operation by increasing a passenger load factor of the flight.

(Configuration 2) The aircraft reservation system according to configuration 1, including a utilization charge reduction unit configured to set a utilization charge of the recommended flight to be lower than a utilization charge of the flight that conforms to the reservation condition, wherein the recommended flight proposal unit transmits the recommended flight proposal information including the utilization charge of the recommended flight to the user terminal.

According to the aircraft reservation system of configuration 2, by reducing the utilization charge, a merit of the user by utilizing the recommended flight can be increased.

(Configuration 3) An aircraft reservation system including: an adjustment target flight extraction unit configured to refer to a flight database in which flight plans and reservation statuses of a plurality of flights are recorded, and extract an adjustment target flight a fourth predetermined time earlier than a scheduled departure date and time and with a reservation rate being a first determination value or lower; an alternative candidate flight extraction unit configured to refer to the flight database, and extract, among examination target flights which have a vacant seat and with the reservation rate being a second determination value higher than the first determination value or higher, a plurality of alternative candidate flights which are the examination target flights satisfying both a utilization spot condition and a utilization date and time condition, the utilization spot condition indicating that a distance between a departure place of the adjustment target flight and a departure place of the examination target flight is a third predetermined distance or shorter and a distance between an arrival place of the adjustment target flight and an arrival place of the examination target flight is a fourth predetermined distance or shorter, the utilization date and time condition indicating that a time difference between a scheduled departure date and time of the adjustment target flight and a scheduled departure date and time of the examination target flight is a fifth predetermined time or shorter or a time difference between a scheduled arrival date and time of the adjustment target flight and a scheduled arrival date and time of the examination target flight is a sixth predetermined time or shorter; a reservation rate estimation unit configured to obtain an estimated reservation rate at the time point the fifth predetermined time earlier than the scheduled departure date and time of the adjustment target flight, for the plurality of alternative candidate flights; an alternative flight selection unit configured to select, as an alternative flight, the alternative candidate flight with the reservation rate at the time point the fourth predetermined time earlier than the scheduled departure date and time of the adjustment target flight being highest or the alternative candidate flight with the estimated reservation rate at the time point a seventh predetermined time earlier than the scheduled departure date and time of the adjustment target flight, obtained by the reservation rate estimation unit, being highest among the plurality of alternative candidate flights; and a flight change proposal unit configured to transmit flight change proposal information which proposes a change of a reservation to the alternative flight to a user terminal used by a user who has a reservation of the adjustment target flight.

According to the aircraft reservation system of configuration 3, by proposing the utilization of the flight of the high reservation rate to the user, it is possible to support the efficient aircraft operation by increasing the passenger load factor of the flight.

(Configuration 4) The aircraft reservation system according to configuration 3, including a utilization charge reduction unit configured to set a utilization charge of the alternative candidate flight to be lower than a utilization charge of the adjustment target flight, wherein the flight change proposal unit transmits the flight change proposal information including the utilization charge of the alternative candidate flight to the user terminal.

According to the aircraft reservation system of configuration 4, by reducing the utilization charge, the merit of the user by changing from the adjustment target flight to the alternative flight can be increased.

(Configuration 5) The aircraft reservation system according to any one of configuration 1 to configuration 4, including a flight cancellation unit configured to cancel a low activity flight with the reservation rate at the time point when an eighth predetermined time earlier than the scheduled departure date and time is reached being a fourth determination value or lower or the estimated reservation rate at the time point a ninth predetermined time earlier than the scheduled departure date and time, obtained by the reservation rate estimation unit, is a fifth determination value or lower, among the flights recorded in the flight database.

According to the aircraft reservation system of configuration 5, execution of a poorly efficient flight in a state of the low passenger load factor can be avoided.

(Configuration 6) The aircraft reservation system according to configuration 5, wherein the flight cancellation unit cancels the low activity flight on condition that the other flights are not affected.

According to the aircraft reservation system of configuration 6, the cancellation of the flight which affects another flight, such as the cancellation of a flight for an outward journey with which a flight for a homeward journey is scheduled, can be avoided.

### REFERENCE SIGNS LIST

1...aircraft reservation system, 10...processor, 11...reservation acceptance unit, 12...recommended candidate flight extraction unit, 13...reservation rate estimation unit, 14...recommended flight selection unit, 15...recommended flight proposal unit, 16...adjustment target flight extraction unit, 17...alternative candidate flight extraction unit, 18...alternative flight selection unit, 19...flight change proposal unit, 20...utilization charge reduction unit, 21...flight cancellation unit, 30...memory, 31...control program, 32...reservation acceptance data, 33...reservation rate estimation map, 50...aircraft, 100...user terminal, 200... communication network, 210...flight management system, 211...flight DB, U...user.

What is claimed is:

1. An aircraft reservation system comprising:
a reservation acceptance unit configured to recognize a reservation condition including a desired departure place, a desired arrival place and a desired departure date and time or a desired arrival date and time by receiving flight reservation condition information transmitted from a user terminal used by a user of an aircraft, and accept a flight reservation;
a recommended candidate flight extraction unit configured to refer to a flight database in which flight plans and reservation statuses of a plurality of flights are recorded, and extract a plurality of recommended candidate flights which satisfy both a utilization spot condition and a utilization date and time condition and have a vacant seat, the utilization spot condition indicating that a distance between a departure place and the desired departure place is a first predetermined distance or shorter and a distance between an arrival place and the desired arrival place is a second predetermined distance or shorter, the utilization date and time condition indicating that a time difference between a scheduled departure date and time and the desired departure date and time is a first predetermined time or shorter or a time difference between a scheduled arrival date and time and the desired arrival date and time is a second predetermined time or shorter;
a recommended flight selection unit configured to select, as a recommended flight, the recommended candidate flight with a reservation rate at a time point when the reservation is accepted by the reservation acceptance unit being highest or the recommended candidate flight with an estimated reservation rate at the time point a third predetermined time earlier than the desired departure date and time, obtained by a reservation rate estimation unit, being highest among the plurality of recommended candidate flights; and
a recommended flight proposal unit configured to transmit recommended flight proposal information which proposes a reservation of the recommended flight to the user terminal.

2. The aircraft reservation system according to claim 1, comprising
a utilization charge reduction unit configured to set a utilization charge of the recommended flight to be lower than a utilization charge of the flight that conforms to the reservation condition,
wherein the recommended flight proposal unit transmits the recommended flight proposal information including the utilization charge of the recommended flight to the user terminal.

3. The aircraft reservation system according to claim 1, comprising
a flight cancellation unit configured to cancel a low activity flight with the reservation rate at the time point when an eighth predetermined time earlier than the scheduled departure date and time is reached being a fourth determination value or lower or the estimated reservation rate at the time point a ninth predetermined time earlier than the scheduled departure date and time, obtained by the reservation rate estimation unit, is a fifth determination value or lower, among the flights recorded in the flight database.

4. The aircraft reservation system according to claim 3,
wherein the flight cancellation unit cancels the low activity flight on condition that the other flights are not affected.

5. An aircraft reservation system comprising:
an adjustment target flight extraction unit configured to refer to a flight database in which flight plans and reservation statuses of a plurality of flights are recorded, and extract an adjustment target flight a fourth predetermined time earlier than a scheduled departure date and time and with a reservation rate being a first determination value or lower;
an alternative candidate flight extraction unit configured to refer to the flight database, and extract, among examination target flights which have a vacant seat and with the reservation rate being a second determination value higher than the first determination value or higher, a plurality of alternative candidate flights which are the examination target flights satisfying both a utilization spot condition and a utilization date and time condition, the utilization spot condition indicating that a distance between a departure place of the adjustment target flight and a departure place of the examination target flight is a third predetermined distance or shorter and a distance between an arrival place of the adjustment target flight and an arrival place of the examination target flight is a fourth predetermined distance or shorter, the utilization date and time condition indicating that a time difference between a scheduled departure date and time of the adjustment target flight and a scheduled departure date and time of the examination target flight is a fifth predetermined time or shorter or a time difference between a scheduled arrival date and time of the adjustment target flight and a scheduled arrival date and time of the examination target flight is a sixth predetermined time or shorter;
a reservation rate estimation unit configured to obtain an estimated reservation rate at the time point the fifth predetermined time earlier than the scheduled departure date and time of the adjustment target flight, for the plurality of alternative candidate flights;
an alternative flight selection unit configured to select, as an alternative flight, the alternative candidate flight with the reservation rate at the time point the fourth predetermined time earlier than the scheduled departure date and time of the adjustment target flight being highest or the alternative candidate flight with the estimated reservation rate at the time point a seventh predetermined time earlier than the scheduled departure date and time of the adjustment target flight, obtained by the reservation rate estimation unit, being highest among the plurality of alternative candidate flights; and
a flight change proposal unit configured to transmit flight change proposal information which proposes a change of a reservation to the alternative flight to a user terminal used by a user who has a reservation of the adjustment target flight.

6. The aircraft reservation system according to claim 5, comprising
a utilization charge reduction unit configured to set a utilization charge of the alternative candidate flight to be lower than a utilization charge of the adjustment target flight,
wherein the flight change proposal unit transmits the flight change proposal information including the utilization charge of the alternative candidate flight to the user terminal.

7. The aircraft reservation system according to claim 5, comprising
a flight cancellation unit configured to cancel a low activity flight with the reservation rate at the time point when an eighth predetermined time earlier than the scheduled departure date and time is reached being a fourth determination value or lower or the estimated reservation rate at the time point a ninth predetermined time earlier than the scheduled departure date and time, obtained by the reservation rate estimation unit, is a fifth determination value or lower, among the flights recorded in the flight database.

8. The aircraft reservation system according to claim 7,
wherein the flight cancellation unit cancels the low activity flight on condition that the other flights are not affected.
